(19) United States
(12) Patent Application Publication
(10) Pub. No.: US 2015/0134196 A1
(43) Pub. Date: May 14, 2015

(54) HYBRID CONSTRUCTION MACHINE, CONTROLLER, AND WRITE PROCESSING METHOD FOR NONVOLATILE MEMORY

(71) Applicant: KAYABA INDUSTRY CO., LTD., Tokyo (JP)

(72) Inventor: Masayuki Kobayashi, Kanagawa (JP)

(73) Assignee: KAYABA INDUSTRY CO., LTD., Tokyo (JP)

(21) Appl. No.: 14/404,960

(22) PCT Filed: Nov. 19, 2013
(86) PCT No.: PCT/JP2013/081170

§ 371 Date: Dec. 2, 2014

(30) Foreign Application Priority Data
Feb. 28, 2013 (JP) 2013-038976

(51) Int. Cl. E02F 9/26; G07C 5/08

(52) U.S. Cl. CPC E02F 9/267; G07C 5/0816; G07C 5/085
USPC 701/33.4

(57) ABSTRACT

A hybrid construction machine includes a hydraulic apparatus having a pump; a regeneration apparatus configured to generate power using energy discharged from the hydraulic apparatus; a nonvolatile memory configured to store condition information indicating whether a condition of at least one of the hydraulic apparatus and the regeneration apparatus is normal or abnormal; a detection unit that detects the condition; a condition determination unit that generates condition information indicating whether the detected condition is normal or abnormal; an information comparison unit that compares the condition information generated by the condition determination unit with the condition information stored in the nonvolatile memory to determine whether or not content thereof is identical; and an updating unit that writes the condition information generated by the condition determination unit to the nonvolatile memory when a comparison result from the information comparison unit indicates that the content is different.

### TECHNICAL FIELD

The present invention relates to a hybrid construction machine, a controller, and a write processing method for a nonvolatile memory.

### BACKGROUND ART

JP2012-205466A discloses a hybrid construction machine that regenerates energy discharged from a hydraulic apparatus.

### SUMMARY OF INVENTION

This type of hybrid construction machine includes a hydraulic apparatus having a pump that drives an actuator by discharging a working fluid, a regeneration apparatus that generates power using energy discharged from the hydraulic apparatus, and a nonvolatile memory capable of storing condition information relating to the hydraulic apparatus and the regeneration apparatus. Condition information indicating abnormalities occurring in the hydraulic apparatus, the regeneration apparatus, and so on is recorded in the nonvolatile memory. A determination as to whether or not an abnormality has occurred is performed repeatedly at predetermined time intervals. When it is determined that an abnormality has occurred, the condition information is recorded in the nonvolatile memory.

However, the determination as to whether or not an abnormality has occurred is performed repeatedly at predetermined time intervals, and therefore, when a certain abnormality occurs continuously over a long time period, the condition information indicating this abnormality is recorded in the nonvolatile memory repeatedly. There is a limit to the number of times information can be rewritten to the nonvolatile memory (the number of possible information updates). Therefore, when the nonvolatile memory is used in an application where data are updated constantly, the life of the nonvolatile memory is shortened. In the result, it may become impossible to record the nature of an occurring abnormality.

An object of the present invention is to provide a hybrid construction machine, a controller, and a write processing method for a nonvolatile memory, with which the life of the nonvolatile memory, which has a limited number of possible information updates, can be extended.

According to an aspect of the present invention, a hybrid construction machine includes a hydraulic apparatus including a pump configured to drive an actuator by discharging a working fluid; a regeneration apparatus configured to generate power using energy discharged from the hydraulic apparatus; a nonvolatile memory configured to store condition information indicating whether a condition of at least one of the hydraulic apparatus and the regeneration apparatus is normal or abnormal; a detection unit that detects the condition; a condition determination unit that generates condition information indicating whether the condition is normal or abnormal on the basis of a detection result of the detection unit; an information comparison unit that compares the condition information generated by the condition determination unit with the condition information stored in the nonvolatile memory to determine whether or not content thereof is identical; and an updating unit that writes the condition information generated by the condition determination unit to the nonvolatile memory when a comparison result from the information comparison unit indicates that the content is different.

### BRIEF DESCRIPTION OF DRAWINGS

FIG. 1 is a schematic view showing a configuration of a fluid pressure control system for a hybrid construction machine according to an embodiment of the present invention.

FIG. 2 is a schematic view showing a configuration of an assist regeneration mechanism connected to the fluid pressure control system.

FIG. 3 is a flowchart showing condition information updating processing executed by a controller installed in the hybrid construction machine.

FIG. 4 is a view showing an example of condition information including information relating to a condition of the hybrid construction machine.

FIG. 5 is a view showing an example of the condition information updating processing.

### DESCRIPTION OF EMBODIMENTS

A hybrid construction machine according to an embodiment of the present invention will be described below with reference to the figures.

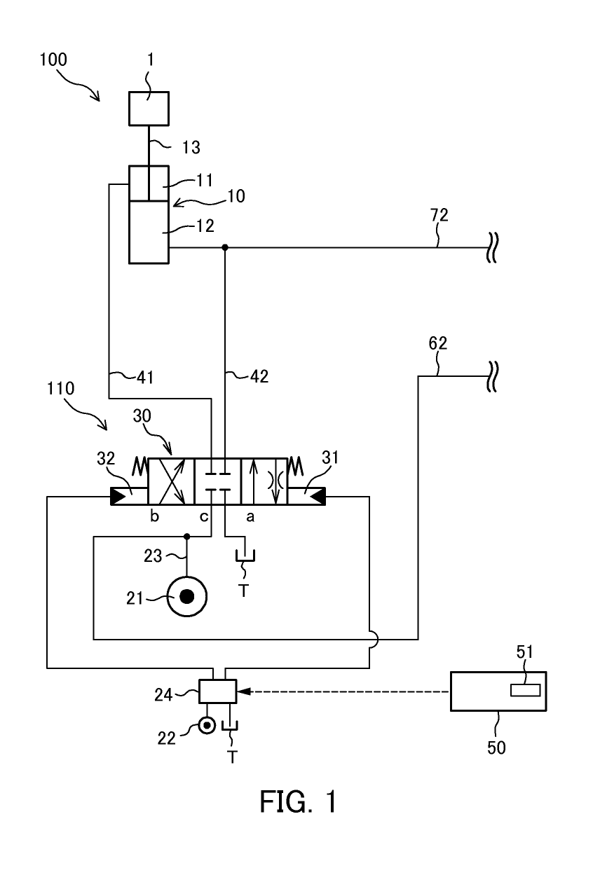

FIG. 1 is a schematic view showing a configuration of a fluid pressure control system 100 provided in the hybrid construction machine according to this embodiment. The fluid pressure control system 100 is an apparatus configured to control an operation of a hydraulic operating machine such as a hydraulic shovel. For example, the fluid pressure control system 100 controls an expansion/contraction operation of a boom cylinder 10 that drives a boom 1 (a load) of a digging attachment of the hydraulic shovel.

The fluid pressure control system 100 includes a boom cylinder 10 serving as an actuator, a main pump 21 that drives the boom cylinder 10 by discharging working oil, a pilot pump 22, a main control valve 30, a main passage 23, a first passage 41, a second passage 42, and a controller 50. The boom cylinder 10, main pump 21, pilot pump 22, main control valve 30, main passage 23, first passage 41, second passage 42, and so on together constitute a hydraulic apparatus 110.

An interior of the boom cylinder 10 is divided into a rod side pressure chamber 11 and a bottom side pressure chamber 12 by a piston rod 13. The piston rod 13 is congiured to slide freely against the boom cylinder 10. The boom 1 is coupled to a tip end of the piston rod 13, which is positioned on an outer side of the boom cylinder 10.

The main pump 21 and the pilot pump 22 are variable capacity hydraulic pumps that serve as oil pressure supply sources from which working oil (a working fluid) is discharged. An amount of working oil discharged by the main pump 21 and the pilot pump 22 can be adjusted by controlling tilt angles of respective swash plates thereof. The main pump 21 and the pilot pump 22 are driven by an engine installed in the hybrid construction machine.

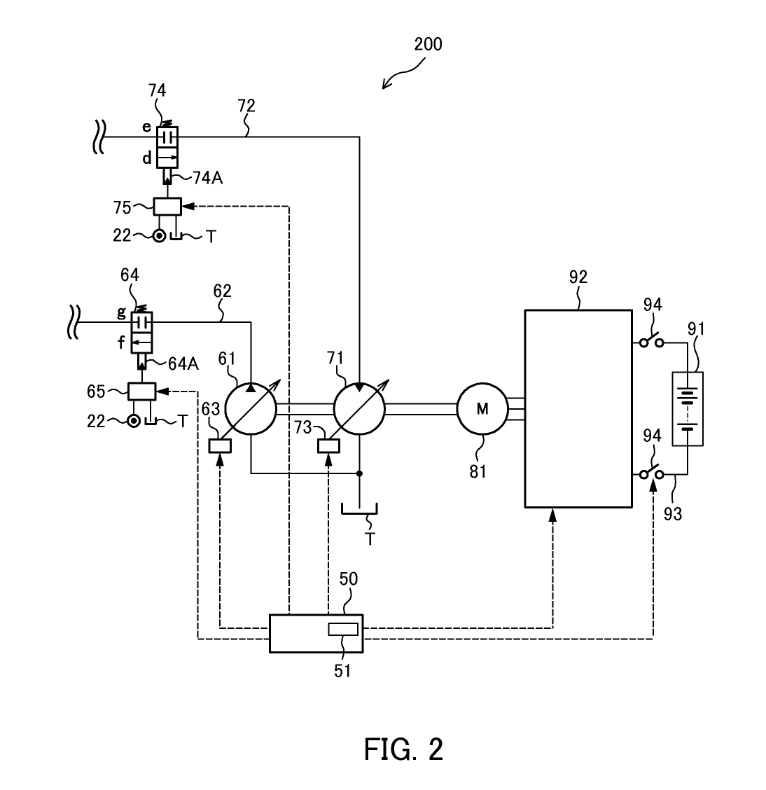

The working oil discharged from the main pump 21 is supplied to the main control valve 30 through the main passage 23. Thus, the main pump 21 and the main control valve 30 are connected to each other by the main passage 23. In addition to the working oil discharged from the main pump 21, working oil discharged from an assist pump 61 of an assist regeneration mechanism 200 (see FIG. 2) is led through a sub passage 62 into the main passage 23.

The main control valve 30 is connected to the rod side pressure chamber 11 of the boom cylinder 10 by the first passage 41, and the main control valve 30 is connected to the bottom side pressure chamber 12 of the boom cylinder 10 by the second passage 42. A return passage 72 into which a part of working oil discharged from the bottom side pressure chamber 12 flows is connected to the second passage 42. The working oil flowing into the return passage 72 drives a regenerative motor 71 of the assist regeneration mechanism 200 (see FIG. 2).

The main control valve 30 is an apparatus that switches between supplying and discharging the working oil to and from the boom cylinder 10. The main control valve 30 is operated by an oil pressure (a pilot pressure) of working oil supplied to pilot chambers 31, 32 of the main control valve 30 from the pilot pump 22. The pilot pressure supplied to the pilot chambers 31, 32 is controlled by having the controller 50 control a pilot solenoid valve 24 on the basis of a lever operation performed by a crew member of the hydraulic shovel.

When the pilot pressure is supplied to the pilot chamber 31, a valve mechanism of the main control valve 30 is switched to a position a. Accordingly, the working oil discharged from the main pump 21 is supplied to the rod side pressure chamber 11 through the first passage 41, and the working oil in the bottom side pressure chamber 12 is discharged into a tank T through the second passage 42. As a result, the piston rod 13 in the boom cylinder 10 moves downward in FIG. 1 such that the boom cylinder 10 contracts, causing the boom 1 to descend.

When the pilot pressure is supplied to the pilot chamber 32, the valve mechanism of the main control valve 30 is switched to a position b. Accordingly, the working oil discharged from the main pump 21 is supplied to the bottom side pressure chamber 12 through the second passage 42, and the working oil in the rod side pressure chamber 11 is discharged into the tank T through the first passage 41. As a result, the piston rod 13 in the boom cylinder 10 moves upward in FIG. 1 such that the boom cylinder 10 expands, causing the boom 1 to ascend.

When the pilot pressure is not supplied to the pilot chambers 31, 32, on the other hand, the valve mechanism of the main control valve 30 is switched to a position c. Accordingly, working oil supply and discharge to and from the boom cylinder 10 is blocked. As a result, expansion and contraction of the boom cylinder 10 is stopped such that the boom 1 is held in a predetermined position.

Hence, the main control valve 30 has three switch positions, namely the contraction position a in which the boom cylinder 10 is caused to contract, the expansion position b in which the boom cylinder 10 is caused to expand, and the blocking position c in which the load of the boom cylinder 10 is held.

The fluid pressure control system 100 further includes the assist regeneration mechanism 200 shown in FIG. 2. The assist regeneration mechanism 200 executes regeneration control, in which a fluid pressure energy of the working oil discharged from the bottom side pressure chamber 12 when the boom cylinder 10 contracts is collected as electric energy. The assist regeneration mechanism 200 executes assist control, in which an auxiliary force is applied when the boom cylinder 10 expands. Thus, the assist regeneration mechanism 200 functions as a regeneration apparatus that generates power using the fluid pressure energy of the working oil discharged from the hydraulic apparatus 110.

As shown in FIG. 2, the assist regeneration mechanism 200 includes a motor/generator 81, the regenerative motor 71, the assist pump 61, a battery 91, an inverter 92, the return passage 72, and the sub passage 62.

The motor/generator 81 is a rotating electric machine that functions as a motor that drives the assist pump 61 on the basis of power from the battery 91, and a power generator that generates power when driven by the regenerative motor 71.

Respective rotary shafts of the motor/generator 81, the regenerative motor 71, and the assist pump 61 are disposed coaxially. When the rotary shaft of the motor/generator 81 is rotated, the rotary shafts of the regenerative motor 71 and the assist pump 61 rotate in conjunction. Similarly, when the rotary shaft of the regenerative motor 71 rotates, the rotary shafts of the motor/generator 81 and the assist pump 61 rotate in conjunction.

The regenerative motor 71 is a variable capacity hydraulic motor, an output torque of which can be controlled by controlling a tilt angle of a swash plate. The regenerative motor 71 is driven by working oil that flows thereto through the return passage 72 after being discharged from the bottom side pressure chamber 12 of the boom cylinder 10. The tilt angle of the swash plate of the regenerative motor 71 is controlled by a tilt angle controller 73. The tilt angle controller 73 is controlled by the controller 50. By controlling the tilt angle of the swash plate of the regenerative motor 71, a discharge capacity of the regenerative motor 71 is varied, leading to variation in a maximum value of the torque that can be generated by the regenerative motor 71.

A return control valve 74 that controls the supply of working oil to the regenerative motor 71 is provided in the return passage 72. A valve mechanism of the return control valve 74 is switched between a communicative position d, in which working oil is supplied to the regenerative motor 71, and a blocking position e, in which the supply of working oil to the regenerative motor 71 is stopped, in accordance with a pilot pressure supplied to a pilot chamber 74A from the pilot pump 22. The pilot pressure supplied to the pilot chamber 74A is controlled by having the controller 50 control a pilot solenoid valve 75 on the basis of a lever operation performed by the crew member of the hydraulic shovel.

The assist pump 61 is a variable capacity hydraulic pump, a discharge amount of which can be controlled by controlling a tilt angle of a swash plate. The assist pump 61 is driven by the motor/generator 81 to supply working oil to the main passage 23 through the sub passage 62. The tilt angle of the swash plate of the assist pump 61 is controlled by a tilt angle controller 63. The tilt angle controller 63 is controlled by the controller 50. By controlling the tilt angle of the swash plate of the assist pump 61, a discharge capacity of the assist pump 61 is varied, leading to variation in a maximum value of a flow rate of the working oil that can be discharged by the assist pump 61.

A sub control valve 64 that controls the supply of working oil to the main passage 23 is provided in the sub passage 62. A valve mechanism of the sub control valve 64 is switched between a communicative position f, in which working oil is supplied to the main passage 23, and a blocking position g, in which the supply of working oil to the main passage 23 is stopped, in accordance with a pilot pressure supplied to a pilot chamber 64A from the pilot pump 22. The pilot pressure supplied to the pilot chamber 64A is controlled by having the controller 50 control a pilot solenoid valve 65 on the basis of a lever operation performed by the crew member of the hydraulic shovel.

The motor/generator 81 is connected to the battery 91, which serves as a storage apparatus, via the inverter 92. The battery 91 is formed by connecting a plurality of secondary battery cells, such as chargeable/dischargeable lithium ion batteries, in series. A relay switch 94 for controlling an electric connection condition is provided on an electric wire 93 connecting the battery 91 to the inverter 92. The relay switches 94 are controlled ON and OFF by the controller 50.

The inverter 92 is controlled by the controller 50 to convert a direct current into an alternating current or an alternating current into a direct current. When the motor/generator 81 is caused to function as a motor, direct current power output from the battery 91 is converted into three-phase alternating current power of a desired frequency, and supplied thus to the motor/generator 81. When the motor/generator 81 is caused to function as a power generator, on the other hand, three-phase alternating current power output from the motor/generator 81 is converted into direct current power and supplied thus to the battery 91.

Referring to FIGS. 1 and 2, actions of the fluid pressure control system 100 of the hybrid construction machine will be described.

First, the regeneration control performed by the assist regeneration mechanism 200, which is implemented as required when the boom 1 descends, will be described.

When the crew member of the hydraulic shovel performs a lever operation to cause the boom cylinder 10 to contract, the valve mechanism of the main control valve 30 is switched to the contraction position a. Accordingly, working oil is supplied to the rod side pressure chamber 11 of the boom cylinder 10, and working oil is discharged from the bottom side pressure chamber 12.

When the battery 91 needs to be charged at this time, the valve mechanism of the return control valve 74 is switched to the communicative position d such that a part of the working oil discharged from the bottom side pressure chamber 12 is supplied to the regenerative motor 71 through the return passage 72. Simultaneously, the tilt angle of the swash plate of the assist pump 61 is controlled such that the capacity of the assist pump 61 is minimized.

As a result, the rotary shaft of the motor/generator 81 rotates synchronously with the rotary shaft of the regenerative motor 71, and therefore power can be generated by the motor/generator 81 and the generated power can be charged to the battery 91. In other words, the oil pressure energy of the working oil discharged from the boom cylinder 10 can be converted into electric energy.

When the battery 91 does not need to be charged, on the other hand, the valve mechanism of the return control valve 74 is switched to the blocking position e so that all of the working oil discharged from the bottom side pressure chamber 12 of the boom cylinder 10 is discharged into the tank T through the second passage 42.

Next, the assist control performed by the assist regeneration mechanism 200, which is implemented as required when the boom 1 ascends, will be described.

When the crew member of the hydraulic shovel performs a lever operation to cause the boom cylinder 10 to expand, the valve mechanism of the main control valve 30 is switched to the expansion position b. Accordingly, working oil is supplied to the bottom side pressure chamber 12 of the boom cylinder 10, and the working oil in the rod side pressure chamber 11 is discharged into the tank T through the first passage 41.

The engine that drives the main pump 21 and so on operates at a predetermined rotation speed and a predetermined load at which a favorable operating efficiency is obtained, and therefore, when the boom cylinder 10 is to be caused to expand quickly, it may be impossible to generate a sufficient flow rate in the working oil supplied to the bottom side pressure chamber 12 with the discharge amount of the main pump 21 alone. In this case, the assist control is executed using the assist regeneration mechanism 200.

In the assist control, the assist pump 61 is driven by driving the motor/generator 81 as a motor using the battery 91. Simultaneously, the tilt angle of the swash plate of the regenerative motor 71 is controlled to minimize the torque of the regenerative motor 71. In so doing, the working oil discharged from the assist pump 61 can be caused to converge on the main passage 23 via the sub passage 62 such that an auxiliary force generated by the assist pump 61 can be applied when the boom cylinder 10 expands. As a result, the boom cylinder 10 can be caused to expand quickly.

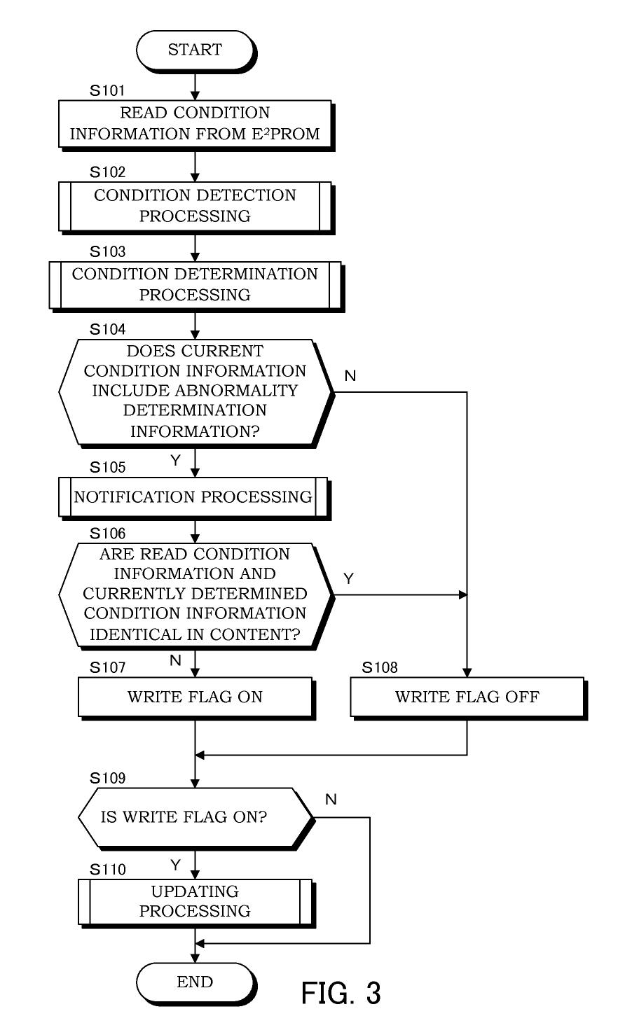

In the hybrid construction machine described above, the controller 50 is configured to monitor conditions (states) of the vehicle during an operation. The controller 50 includes an E²PROM 51 (see FIG. 1) capable of storing vehicle condition information, and updates the condition information in the E²PROM 51 to latest information by executing condition information updating processing shown in FIG. 3. The E²PROM 51 is a nonvolatile memory in which the number of times information can be rewritten (the number of possible information updates) is limited. It should be noted that, although an E²PROM is used in this embodiment as the nonvolatile memory for storing the condition information, a flash memory, an MRAM, or the like may be used instead.

Referring to FIG. 3, the condition information updating processing executed by the controller 50 of the hybrid construction machine will be described. The condition information updating processing is executed at period intervals of several milliseconds while the hybrid construction machine is operative.

In a step 101 (S101), the controller 50 reads the condition information relating to the hybrid construction machine (the vehicle), which is stored in the E²PROM 51. It should be noted that when the condition information is read from the E²PROM 51, the latest condition information stored in the E²PROM 51 is read.

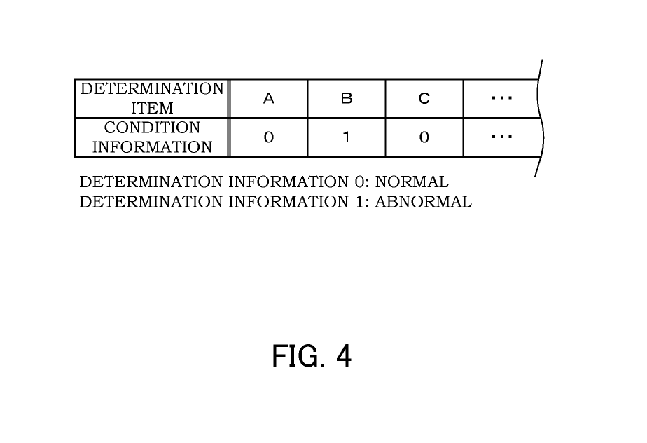

The vehicle condition information is information for determining whether the condition of at least one of the hydraulic apparatus 110 and the assist regeneration mechanism 200 serving as a regeneration apparatus is normal or abnormal. As shown in FIG. 4, the vehicle condition information includes a plurality of determination items, and determination information determined for each determination item. Determination information 0 indicates a normal condition, and determination information 1 indicates an abnormal condition. The controller 50 makes determinations in relation to determination items such as a power supply voltage and a substrate temperature of the controller 50, a current value and a temperature of the battery 91, a temperature of the motor/generator 81, an operating condition of a pressure sensor that detects the oil pressure of the working oil, and operating conditions of the tilt angle controllers 63, 73, for example.

In S102, the controller 50 executes condition detection processing. In this processing, the controller 50 detects current conditions of the plurality of determination items. Hence, the controller 50 includes a detection unit that detects a condition of the vehicle constituted by the hydraulic apparatus 110, the assist regeneration mechanism 200, and so on.

In S103, the controller 50 executes condition determination processing. In this processing, the controller 50 determines whether the plurality of determination items are in a normal condition or an abnormal condition, and generates condition information including determination information obtained in relation to each determination item, as shown in FIG. 4. Hence, the controller 50 includes a condition determination unit that generates condition information by determining the condition of the vehicle.

In S104, the controller 50 determines whether or not the current condition information generated in S103 includes abnormal determination information (the determination information 1).

When it is determined in S104 that one of the determination items of the condition information includes abnormal determination information, the controller 50 executes processing of S105.

In S105, the controller 50 executes notification processing. In this processing, the controller 50 notifies the crew member and so on of the abnormal determination information included in the condition information determined in S104. Hence, the controller 50 includes a notification unit that notifies the crew member and so on of the abnormal determination information. The controller 50 notifies the crew member of the determination item that includes the abnormal determination by displaying the notification on a display, via a lamp, or the like, or via a buzzer, a voice, and so on. As a result, the crew member can acknowledge the abnormality. It should be noted that the crew member is preferably notified not only of the included abnormality determination, but also, via a display or the like, of the determination item in which the abnormality has occurred.

In S106, the controller 50 compares the condition information read from the E²PROM 51 in S101 with the current condition information generated in S103 to determine whether or not the two sets of condition information are identical in content. Hence, the controller 50 includes an information comparison unit that compares the two sets of condition information described above.

When it is determined in S106 that the determination information relating to the corresponding determination item differs between the condition information read from the E²PROM 51 and the condition information generated in S103, the controller 50 executes processing of S107. It should be noted that when no condition information is stored in the E²PROM 51 in S101, it is determined that the determination information is different.

In S107, the controller 50 sets a write flag to ON to allow the condition information in the E²PROM 51 to be updated.

When, on the other hand, it is determined in S104 that abnormal determination information is not included in the condition information, or it is determined in S106 that the determination information relating to all of the determination items is identical in the two sets of condition information, the controller 50 executes processing of S108.

In S108, the controller 50 sets the write flag to OFF to prohibit updating of the condition information in the E²PROM 51.

In S109 following the processing of S107 or S108, the controller 50 determines whether or not the write flag is set at ON.

When it is determined in S109 that the write flag is set at ON, the controller 50 determines that new abnormality determination information is included in the currently determined condition information, and executes updating processing in S110.

In S110, the controller 50 updates the condition information in the E²PROM 51 by writing the condition information generated in S103 to the E²PROM 51, and then terminates the condition information updating processing. Hence, the controller 50 includes an updating unit that updates the condition information in the E²PROM 51.

When it is determined in S109 that the write flag is set at OFF, on the other hand, the controller 50 determines that there is no need to update the condition information stored in the E²PROM 51, and therefore terminates the condition information updating processing without executing the updating processing of S110.

It should be noted that in the condition information updating processing, the processing of S104, S105, and S106 is executed in that order, but the processing of S106 may be executed after the processing of S103, whereupon the processing of S104 and S105 are executed in that order.

With the controller 50 of the hybrid construction machine according to the embodiment described above, following effects are obtained.

The controller 50 executes the condition information updating processing at predetermined period intervals, and updates the condition information by writing the currently generated condition information to the E²PROM 51 only when the vehicle condition information generated during execution of the condition information updating processing differs in content from the condition information stored in the E²PROM 51. Therefore, a frequency with which the condition information is updated can be reduced in comparison with a conventional method in which the condition information is updated every time the vehicle condition information (the information relating to the condition of at least one of the hydraulic apparatus 110 and the assist regeneration mechanism 200) is determined. As a result, the life of the E²PROM 51 serving as the nonvolatile memory can be extended.

Further, the condition information includes the plurality of determination items and the normal determination information or abnormal determination information for each determination item. The controller 50 updates the condition information when the determination information relating to the corresponding determination item differs between the vehicle condition information generated during execution of the condition information updating processing and the condition information stored in the E²PROM 51. Hence, the conditions of the plurality of determination items can be managed and updated together, and the frequency with which the large amount of condition information is updated can be reduced. As a result, the life of the E²PROM 51 can be extended even further.

An embodiment of the present invention was described above, but the above embodiment is merely one example of an application of the present invention, and the technical scope of the present invention is not limited to the specific configurations of the above embodiment.

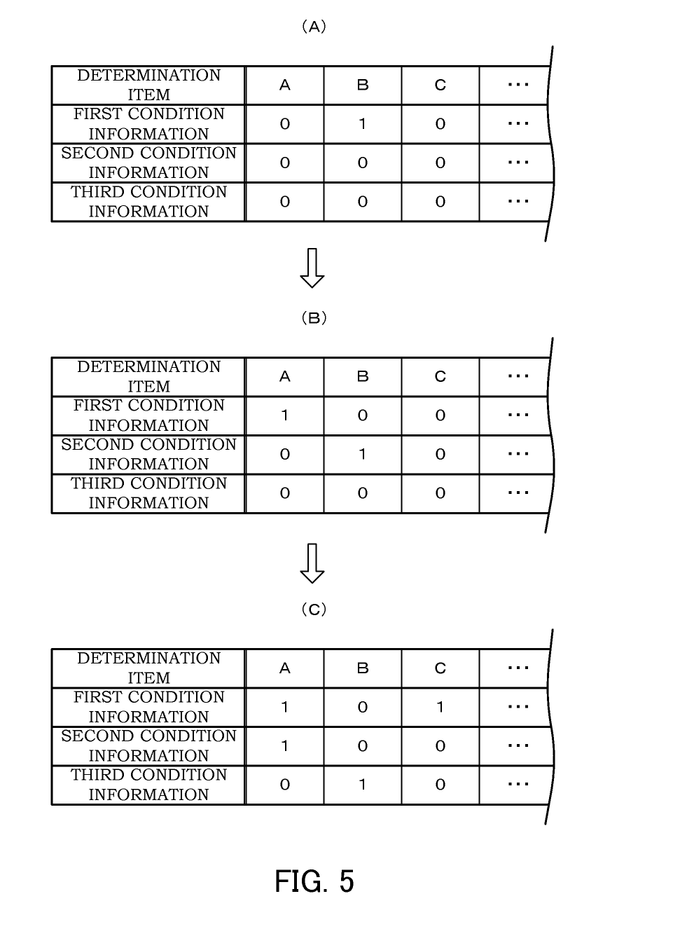

In the condition information updating processing performed by the controller 50 of the hybrid construction machine according to this embodiment, a plurality of previous sets of condition information may be stored in the E²PROM 51. As shown in FIGS. 5A to 5C, for example, three previous sets of condition information may be stored in the E²PROM 51.

In this case, when an abnormality is detected in a determination item B in the hybrid construction machine, condition information including abnormality information (the determination information 1) is written to the E²PROM 51 in relation to the determination item B as first condition information, as shown in FIG. 5A. Then, as shown in FIG. 5B, when the determination item B returns to normal but an abnormality is detected in the determination item A, the condition information stored as the first condition information is stored in the E²PROM 51 as second condition information, and the latest condition information including the abnormality information relating to the determination item A is written to the E²PROM 51 as the first condition information. Accordingly, data stored as the first condition information are shifted to an address of the second condition information. Then, as shown in FIG. 5C, when an abnormality is detected in the determination item C in addition to the abnormality in the determination item A, the condition information that was stored as the second condition information is stored in the E²PROM 51 as third condition information, the condition information that was stored as the first information is stored in the E²PROM 51 as the second condition information, and the latest condition information including the abnormality information relating to the determination item A and the determination item C is written to the E²PROM 51 as the first condition information. Accordingly, data stored as the second condition information are shifted to an address of the third condition information, and the data stored as the first condition information are shifted to the address of the second condition information.

By storing three sets of past condition information in the E²PROM 51 in the manner described above, the nature of the abnormalities and the order in which they occurred can be analyzed, and a cause of the abnormalities in the hybrid construction machine can be investigated more easily. In the above description, three sets of past condition information are stored in the E²PROM 51, but the number of sets of stored condition information may be set as desired in accordance with requirements.

Furthermore, in the condition information updating processing performed by the controller 50, processing may be executed to calculate a number of consecutive non-updates, i.e. a consecutive number of times the condition information is not updated, and write the number of consecutive non-updates to the E²PROM 51. When the condition information in the E²PROM 51 is updated, the number of consecutive non-updates is set at zero.

Moreover, in the condition information updating processing performed by the controller 50, the condition information may be recorded in the E²PROM 51 even when no abnormality determination information is included in the condition information, and furthermore, time information and the like may also be recorded. In so doing, it is possible to record the time at which the abnormality occurred and the time at which the abnormal condition returned to a normal condition.

Furthermore, the fluid pressure control system 100 is a system for controlling an operation of the boom cylinder 10, but may be a system for controlling operations of a plurality of actuators such as an arm cylinder, a bucket cylinder, a travel motor, and a turning motor of the hybrid construction machine.

Moreover, in the fluid pressure control system 100, working oil is used as the working fluid, but water, a water-soluble replacement fluid, or the like may be used instead of working oil.

Further, in the fluid pressure control system 100, the regenerative motor is driven to perform regeneration by the working fluid discharged from the actuator. However, in the fluid pressure control system 100, the actuator and the motor/generator may be coupled mechanically by a driving force transmission mechanism such as a wire rope, whereby the regeneration control or the assist control is executed using kinetic energy.

This application claims priority based on Japanese Patent Application No. 2013-38976, filed with the Japan Patent Office on Feb. 28, 2013, the entire contents of which are incorporated into this specification by reference.

1. A hybrid construction machine comprising:
a hydraulic apparatus including a pump configured to drive an actuator by discharging a working fluid;
a regeneration apparatus configured to generate power using energy discharged from the hydraulic apparatus;
a nonvolatile memory configured to store condition information indicating whether a condition of at least one of the hydraulic apparatus and the regeneration apparatus is normal or abnormal;
a detection unit that detects the condition;
a condition determination unit that generates condition information indicating whether the condition is normal or abnormal on the basis of a detection result of the detection unit;
an information comparison unit that compares the condition information generated by the condition determination unit with the condition information stored in the nonvolatile memory to determine whether or not content thereof is identical; and
an updating unit that writes the condition information generated by the condition determination unit to the nonvolatile memory when a comparison result from the information comparison unit indicates that the content is different.

2. The hybrid construction machine as defined in claim 1, wherein the condition information indicates whether each of a plurality of determination items is normal or abnormal,
the information comparison unit compares the condition information generated by the condition determination unit with the condition information stored in the nonvolatile memory to determine whether or not all of the corresponding determination items are identical, and
when at least one of the determination items is different in the comparison result of the information comparison unit, the updating unit writes the condition information generated by the condition determination unit to the nonvolatile memory.

3. The hybrid construction machine as defined in claim 1, wherein the information comparison unit or the updating unit executes processing only when the condition information generated by the condition determination unit includes abnormality information.

4. The hybrid construction machine as defined in claim 1, further comprising a notification unit that issues a notification of an abnormality in a determination result of the condition determination unit when the condition information generated by the condition determination unit includes the abnormality information.

5. A controller of a hybrid construction machine having a hydraulic apparatus including a pump configured to drive an actuator by discharging a working fluid and a regeneration apparatus configured to generate power using energy discharged from the hydraulic apparatus, comprising:
a nonvolatile memory configured to store condition information indicating whether a condition of at least one of the hydraulic apparatus and the regeneration apparatus is normal or abnormal;
a detection unit that detects the condition;
a condition determination unit that generates condition information indicating whether the condition is normal or abnormal on the basis of a detection result of the detection unit;
an information comparison unit that compares the condition information generated by the condition determination unit with the condition information stored in the nonvolatile memory to determine whether or not content thereof is identical; and
an updating unit that writes the condition information generated by the condition determination unit to the nonvolatile memory when a comparison result from the information comparison unit indicates that the content is different.

6. A write processing method for a nonvolatile memory configured to store condition information indicating whether a condition of at least one of a hydraulic apparatus including a pump configured to drive an actuator by discharging a working fluid and a regeneration apparatus configured to generate power using energy discharged from the hydraulic apparatus is normal or abnormal, comprising:
a detection step for detecting the condition;
a condition determination step for generating condition information indicating whether the condition is normal or abnormal on the basis of a detection result obtained in the detection step;
an information comparison step for comparing the condition information generated in the condition determination step with the condition information stored in the nonvolatile memory to determine whether or not content thereof is identical; and
an updating step for writing the condition information generated in the condition determination step to the nonvolatile memory when a comparison result obtained in the information comparison step indicates that the content is different.
